(19) United States
(12) Patent Application Publication
(10) Pub. No.: US 2024/0394609 A1
(43) Pub. Date: Nov. 28, 2024

(54) METHOD AND APPARATUS FOR PROVIDING THE OCCUPANCY STATUS OF SHARED FACILITIES BASED ON BIG DATA

(71) Applicant: GOSOO PLUS CO., LTD., Incheon (KR)

(72) Inventor: Doo Soo KIM, Seoul (KR)

(73) Assignee: GOSOO PLUS CO., LTD., Incheon (KR)

(21) Appl. No.: 18/670,814

(22) Filed: May 22, 2024

Related U.S. Application Data
(63) Continuation of application No. PCT/KR2024/006109, filed on May 7, 2024.

(30) Foreign Application Priority Data
May 26, 2023 (KR) 10-2023-0068724

(51) Int. Cl. G06Q 10/02

(52) U.S. Cl. CPC G06Q 10/02

(57) ABSTRACT

A method for providing an occupancy status of shared facilities based on big data includes: receiving sensing data indicating an occupancy state of shared facilities from a facility sensing terminal in a residential space, in the residential space where a plurality of users live while sharing certain facilities of a house; generating information on an occupancy status for the shared facility based on the sensing data, residential space information collected for the residential space, and big data information collected for other residential spaces; and providing information on an occupancy status for the shared facility through a user application.

### CROSS-REFERENCE TO RELATED APPLICATION

This application is a Continuation of PCT International Patent Application No. PCT/KR2024/006109 filed on May 7, 2024, under 35 U.S.C. § 371, which claims priority to Korean Patent Application No. 10-2023-0068724 filed on May 26, 2023 in the Korean Intellectual Property Office (KIPO), the entire disclosure of which is incorporated herein by reference.

### BACKGROUND

The present invention relates to a method and apparatus for providing an occupancy status of shared facilities based on big data.

The contents that will be described below simply provide background information related to one embodiment of the present invention without constituting the related art.

In general, in order to efficiently manage shared facilities used by a plurality of users, such as an apartment house, a conference room in an office, or a shared office, users face a manager to check whether a reservation is available, and convey a desired time and period to a manager to reserve a space.

In another way, a manager receives an application for reservation from an applicant who wants to use and adjusts the period and space to be used, and in general, at a large scale, the manager receives a reservation using a communication network such as the Internet and informs whether the reservation is available.

In reality, however, the above-described reservation method has an inconvenience of having the user and the manager to check whether the reservation for a target space is available with each other every time, and there is a problem that the space may not be appropriately used at a time when the actual use is required due to an error in delivering information during face-to-face or telephone consultation.

Another problem is that when a reservation is changed or canceled, such content is not properly transmitted and is not supplied to the user who needs space, thus causing time-related and economic damage to both the manager and the user.

Accordingly, there is a need for a process and a system which allow a user and a manager to grasp information on idle/occupied space of shared facilities including an office, an apartment, an officetel, and a shared office which are gradually becoming larger in real time, and find available information based on an experience of use to increase utilization efficiency, thus increasing convenience of commercial use and management.

### DISCLOSURE

### Technical Problem

An object of the present invention is to provide an occupancy status of shared facilities.

In addition, another object of the present invention is to generate information on an occupancy status using sensing data indicating an occupancy state of shared facilities.

Furthermore, still another object of the present invention is to generate information on an occupancy status using a degree of congestion and interest in shared facilities.

### Technical Solution

To achieve the objects described above, a method for providing an occupancy status of shared facilities based on big data according to one embodiment of the present invention may include: receiving sensing data indicating an occupancy state of shared facilities from a facility sensing terminal in a residential space, in the residential space where a plurality of users live while sharing certain facilities of a house; generating information on an occupancy status for the shared facility based on the sensing data, residential space information collected for the residential space, and big data information collected for other residential spaces; and providing information on an occupancy status for the shared facility through a user application.

The receiving of sensing data may include: receiving first sensing data including whether a user is present in any one space of the shared facility from a presence sensing terminal; or receiving second sensing data including whether a user uses a facility from the facility having an Internet of Things (IoT) function.

The generating of information on the occupancy status may include: calculating a degree of interest in the shared facility based on an interaction performed through the user application; and generating information on the occupancy status further based on the degree of interest.

The generating of information on the occupancy status may include: calculating an occupancy rate of the shared facility based on the sensing data; calculating a degree of congestion in the shared facility based on the occupancy rate and the residential space information; and generating information on the occupancy status further based on the degree of congestion, in which the residential space information may include the number of shared facilities in the residential space or the number of users residing in the residential space.

The calculating of the degree of congestion may include: calculating the degree of congestion further based on the interaction performed through the user application, and the calculating of the degree of congestion may include: calculating the degree of congestion based on a first criterion which causes the degree of congestion to increase as the number of users who have applied for notification of availability of the shared facility through the user application increases; or calculating the degree of congestion based on a second criterion which causes the degree of congestion to increase as the number of users who have checked the occupancy state of the shared facility while the shared facility is occupied.

The calculating of the degree of congestion may include: calculating the degree of congestion based on a third criterion which causes the degree of congestion to increase as an interval from a time when the occupancy of the shared facility is released to a time when the occupancy is resumed becomes narrow.

The providing of information on the occupancy status may include: providing a notification to a manager terminal of the residential space, when the degree of congestion in the residential space is higher than a reference degree of congestion calculated from the degrees of congestion in other residential spaces, for the shared facility and same type of shared facilities.

It may further include: providing the residential spaces in a form of list by matching residential space information and occupancy status information for each of a plurality of residential spaces.

The providing of the residential spaces in the form of list may include: calculating a weight of the shared facility based on a filter setting for viewing the shared facility with a higher priority than that of other shared facilities, which is performed through another user application; calculating a total score of degrees of congestion in all shared facilities of the residential space based on a value obtained by applying the weight to the degree of congestion in the shared facilities; and adjusting an order on a list of the residential spaces based on the total score of degrees of congestion.

In addition, an apparatus for providing an occupancy status of shared facilities based on big data according to one embodiment of the present invention may include: a memory with at least one program recorded therein; and a processor for executing the program, in which the program may include: receiving sensing data indicating an occupancy state of shared facilities from a facility sensing terminal in a residential space, in the residential space where a plurality of users live while sharing certain facilities of a house; generating information on an occupancy status for the shared facility based on the sensing data, residential space information collected for the residential space, and big data information collected for other residential spaces; and providing information on an occupancy status for the shared facility through a user application.

### Advantageous Effects

According to the present invention, an occupancy status of shared facilities can be provided.

In addition, according to the present invention, information on an occupancy status can be generated by using sensing data indicating an occupancy state of shared facilities.

Furthermore, according to the present invention, information on an occupancy status can be generated by using a degree of congestion and interest in shared facilities.

### BRIEF DESCRIPTION OF DRAWINGS

FIG. 1 is a block view showing entities for providing an occupancy status of shared facilities based on big data according to one embodiment of the present invention.

FIG. 2 is an operation flowchart showing a method for providing an occupancy status of shared facilities based on big data according to one embodiment of the present invention.

FIG. 3 is an operation flowchart showing a method for providing an occupancy status of shared facilities based on big data according to one embodiment of the present invention.

FIG. 4 is an operation flowchart showing a method for providing an occupancy status of shared facilities based on big data according to one embodiment of the present invention.

FIG. 5 is a view showing a computer system according to one embodiment of the present invention.

### DETAILED DESCRIPTION OF INVENTION

The present invention will be described in detail below with reference to the accompanying drawings. In this case, redundant descriptions and detailed descriptions of well-known functions and configurations that may unnecessarily obscure the gist of the present invention will be omitted. Embodiments of the present invention are provided to more completely describe the present invention to a person having ordinary skill in the art. Therefore, shapes, sizes, and the like of elements in the drawings may be exaggerated for a clearer description.

Throughout the present specification, when some part “includes” some components, unless explicitly described to the contrary, it means that other elements may be further included but not excluded.

Hereinafter, preferred embodiments of the present invention will be described in detail with reference to the accompanying drawings.

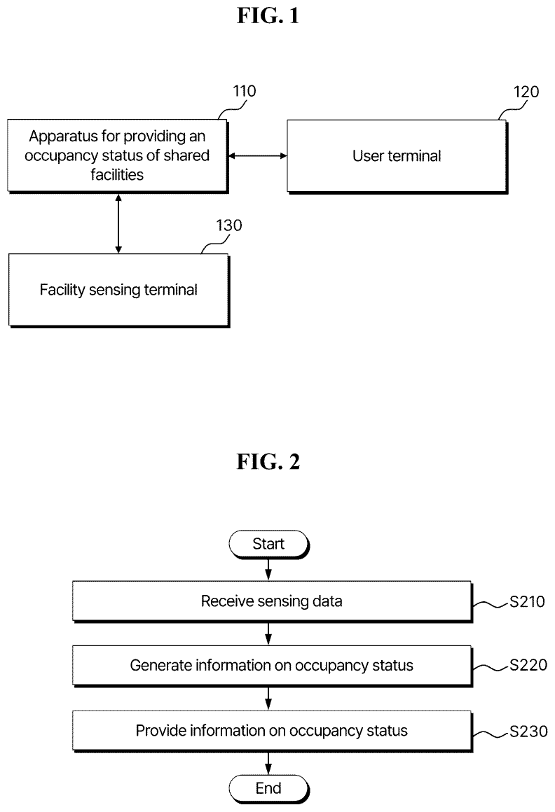

FIG. 1 is a block view showing entities for providing an occupancy status of shared facilities based on big data according to one embodiment of the present invention.

Referring to FIG. 1, entities for providing an occupancy status of shared facilities based on big data according to one embodiment of the present invention may include an apparatus for providing an occupancy status of shared facilities 110, a user terminal 120, and a facility sensing terminal 130.

The apparatus for providing the occupancy status of shared facilities 110 may refer to an apparatus for receiving sensing data indicating an occupancy status of shared facilities from the facility sensing terminal 130.

The apparatus for providing the occupancy status of shared facilities 110 may refer to an apparatus for generating information on an occupancy status of shared facilities by using sensing data, residential space information, and big data information collected for other residential spaces.

The apparatus for providing the occupancy status of shared facilities 110 may be an apparatus which provides information on an occupancy status for the shared facility to a user terminal 120.

The user terminal 120 may be a device which receives information on an occupancy status for the shared facility from the apparatus for providing the occupancy status of shared facilities 110.

The facility sensing terminal 130 may be a device which senses an occupancy state of the shared facility in the residential space and provides sensing data indicating the occupancy state to the apparatus for providing the occupancy status of shared facilities 110.

The apparatus for providing the occupancy status of shared facilities 110 and the user terminal 120, and the apparatus for providing the occupancy status of shared facilities 110 and the facility sensing terminal 130 may be connected to each other through a communication network.

The communication network may refer to a connection path for transmitting and receiving data between the above entities. For example, the communication network may encompass wired networks such as local area networks (LANs), wide area networks (WANs), metropolitan area networks (MANs), integrated service digital networks (ISDNs), etc., or wireless networks such as wireless LANs, CDMA, Bluetooth, satellite communications, etc., but the scope of the communication network applicable to the present invention is not limited thereto.

FIG. 2 is an operation flowchart showing a method for providing an occupancy status of shared facilities based on big data according to one embodiment of the present invention.

Referring to FIG. 2, in the method for providing the occupancy status of shared facilities based on big data according to one embodiment of the present invention, first, sensing data indicating an occupancy state of shared facilities may be received from a facility sensing terminal in a residential space, in the residential space where a plurality of users live while sharing certain facilities of a house (S210).

Here, the shared facilities may refer to facilities used by a plurality of users together or alternately in a residential space, and may include a kitchen, a toilet, a shower room, a laundry room, a lounge, a conference room, and the like. The shared facilities of the present invention are not limited to the above-listed facilities, and may include all other types of shareable facilities.

Then, information on an occupancy status for the shared facility may be generated based on the sensing data, residential space information collected for the residential space, and big data information collected for other residential spaces (S220).

After that, information on an occupancy status for the shared facility may be provided through a user application (S230).

According to one embodiment, above S210 may include: receiving first sensing data including whether a user is present in any one space of the shared facility from a presence sensing terminal; or receiving second sensing data including whether a user uses a facility from the facility having an Internet of Things (IoT) function.

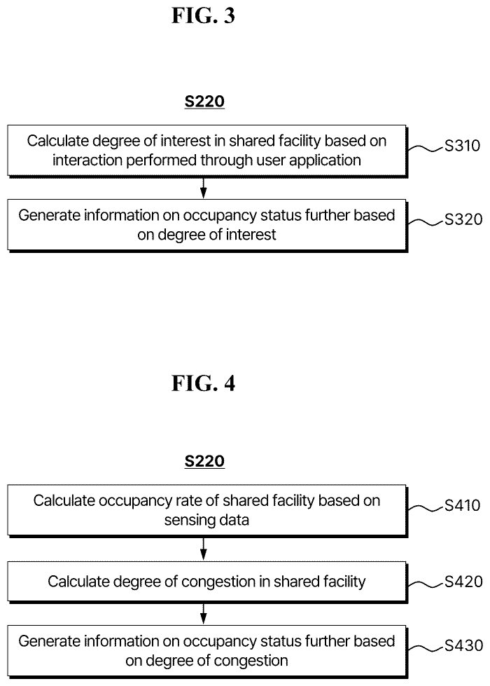

FIG. 3 is an operation flowchart showing a method for providing an occupancy status of shared facilities based on big data according to one embodiment of the present invention.

Referring to FIG. 3, in the method for providing the occupancy status of shared facilities based on big data according to one embodiment of the present invention, a degree of interest in the shared facility may be calculated based on an interaction performed through the user application (S310).

For example, the degree of interest may be calculated based on the number of users who have checked information on the occupancy status for any one shared facility within a recent predetermined time through the user application.

In this case, the shared facilities may be a space such as a kitchen, a toilet, or the like, or may be facilities such as a home appliance capable of Internet of Things (IoT) which may be used in the shared facilities.

Then, information on the occupancy status may be generated further based on the degree of interest (S320).

FIG. 4 is an operation flowchart showing a method for providing an occupancy status of shared facilities based on big data according to one embodiment of the present invention.

Referring to FIG. 4, in the method for providing the occupancy status of shared facilities based on big data according to one embodiment of the present invention, an occupancy rate of the shared facility may be calculated based on the sensing data (S410).

Then, a degree of congestion in the shared facility may be calculated based on the occupancy rate and the residential space information (S420).

In this case, the degree of congestion may be calculated according to the occupancy rate of the shared facility for each time zone. In addition, a change in the degree of congestion according to a change in the occupancy rate for each time zone may also be calculated.

Then, information on the occupancy status may be generated further based on the degree of congestion (S430).

In this case, the residential space information may include the number of shared facilities in the residential space or the number of users residing in the residential space.

Accordingly, information on an occupancy status according to a degree of congestion for each time zone may be provided to users residing in a residential space, thereby providing information on which shared facilities are congested. In addition, information on an occupancy status according to a degree of congestion for each time zone may be provided to an external user who does not reside in a residential space through a user application, thereby providing an effect of grasping information in advance before the external user moves into the residential space.

According to one embodiment, above S420 may include calculating the degree of congestion further based on an interaction performed through the user application.

In this case, the calculating of the degree of congestion may be configured to calculate the degree of congestion based on a first criterion which causes the degree of congestion to increase as the number of users who have applied for notification of availability of the shared facility through the user application increases.

Here, the large number of users who have applied for notification of availability may mean that there are many users who want to use the corresponding shared facility for the same time zone, and thus the degree of congestion may be calculated high at the corresponding time zone.

In addition, the calculating of the degree of congestion may be configured to calculate the degree of congestion based on a second criterion which causes the degree of congestion to increase as the number of users who have checked the occupancy state of the shared facility while the shared facility is occupied.

Here, the large number of users who have checked the occupancy state may mean that there are many other users who want to use after a current user, and thus the degree of congestion may be calculated high.

According to one embodiment, above S420 may include: calculating the degree of congestion based on a third criterion which causes the degree of congestion to increase as an interval from a time when the occupancy of the shared facility is released to a time when the occupancy is resumed becomes narrow.

According to one embodiment, above S220 may include: providing a notification to a manager terminal of the residential space, when the degree of congestion in the residential space is higher than a reference degree of congestion calculated from the degrees of congestion in other residential spaces, for the shared facility and same type of shared facilities.

Here, the manager terminal may be a terminal of a manager who operates and manages a residential space, and may include, for example, a terminal of a chief of an accommodation for examinees, a terminal of a building manager of shared facilities, or the like.

Accordingly, it may inform the manager that it is necessary to solve the congestion of shared facilities in the residential space.

According to one embodiment, the method for providing the occupancy status of shared facilities based on big data may further include: providing the residential spaces in a form of list by matching residential space information and occupancy status information for each of a plurality of residential spaces.

For example, a list of residential spaces may be provided to external users who want to move into the residential space.

In this case, the providing of the residential spaces in the form of list may be configured to calculate a weight of the shared facility based on a filter setting for viewing the shared facility with a higher priority than that of other shared facilities, which is performed through another user application.

Then, a total score of degrees of congestion in all shared facilities of the residential space may be calculated based on a value obtained by applying the weight to the degree of congestion in the shared facilities.

After that, an order on a list of the residential spaces may be adjusted based on the total score of degrees of congestion.

Accordingly, the list of residential spaces may be provided by filtering information about facilities which are considered important by users who want to move into the residential spaces. In addition, information on facilities which are considered important by users may be collected to make big data, which may be provided to a manager who manages the residential space.

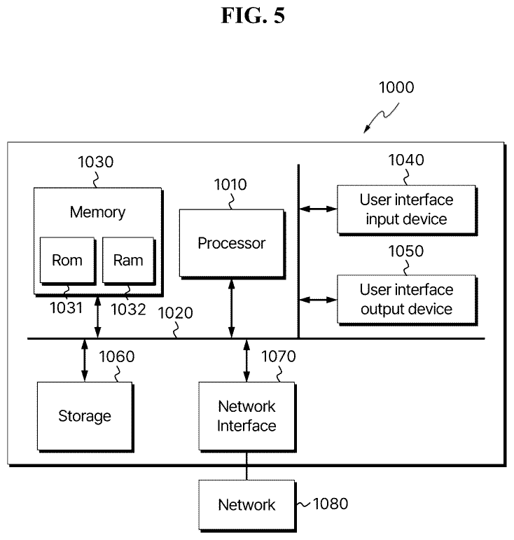

FIG. 5 is a view showing a computer system according to one embodiment of the present invention.

The apparatus for providing an occupancy status of shared facilities based on big data according to one embodiment of the present invention may be implemented in a computer system 1000 such as a computer-readable recording medium.

Referring to FIG. 5, the computer system 1000 may include one or more processors 1010, a memory 1030, a user-interface input device 1040, a user-interface output device 1050, and a storage 1060, which communicate with each other via a bus 1020. In addition, the computer system 1000 may further include a network interface 1070 connected to a network 1080. The processor 1010 may be a semiconductor device for executing processing instructions stored in a central processing unit, the memory 1030 or the storage 1060. The memory 1030 and the storage 1060 may be various types of volatile or nonvolatile storage media. For example, the memory may include ROM 1031 or RAM 1032.

The specific executions described in the present invention may be examples and do not limit the scope of the present invention in any way. For the sake of brevity, description of conventional electronic configurations, control systems, software, and other functional aspects of the systems may be omitted. In addition, the connection or connection members of lines between the components illustrated in the drawings are exemplarily illustrated as functional connections and/or physical or circuit connections, and may be referred to as alternate or additional various functional connections, physical connections, or circuit connections in actual devices. Furthermore, if there is no specific mention such as “essential,” “important” and the like, it may not be an essential component for the application of the present invention.

Therefore, the spirit of the present invention should not be limited to the above-described embodiments, and all scopes equivalent to or equivalently changed from the claims as well as the claims described below would be considered to fall within the scope of the spirit of the present invention.

1. A method for providing an occupancy status of shared facilities based on big data, the method comprising:
receiving sensing data indicating an occupancy state of shared facilities from a facility sensing terminal in a residential space, in the residential space where a plurality of users live while sharing certain facilities of a house;
generating information on an occupancy status for the shared facility based on the sensing data, residential space information collected for the residential space, and big data information collected for other residential spaces; and
providing information on the occupancy status for the shared facility through a user application.

2. The method of claim 1, wherein the receiving of sensing data includes:
receiving first sensing data including whether a user is present in any one space of the shared facility from a presence sensing terminal; or receiving second sensing data including whether a user uses a facility from the facility having an Internet of Things (IoT) function.

3. The method of claim 1, wherein the generating of information on the occupancy status includes:
calculating a degree of interest in the shared facility based on an interaction performed through the user application; and
generating information on the occupancy status further based on the degree of interest.

4. The method of claim 1, wherein the generating of information on the occupancy status includes:
calculating an occupancy rate of the shared facility based on the sensing data;
calculating a degree of congestion in the shared facility based on the occupancy rate and the residential space information; and
generating information on the occupancy status further based on the degree of congestion,
in which the residential space information includes a number of shared facilities in the residential space or a number of users residing in the residential space.

5. The method of claim 4, wherein the calculating of the degree of congestion includes:
calculating the degree of congestion further based on the interaction performed through the user application,
in which the calculating of the degree of congestion includes:
calculating the degree of congestion based on a first criterion which causes the degree of congestion to increase as a number of users who have applied for notification of availability of the shared facility through the user application increases; or
calculating the degree of congestion based on a second criterion which causes the degree of congestion to increase as a number of users who have checked the occupancy state of the shared facility while the shared facility is occupied.

6. The method of claim 4, wherein the calculating of the degree of congestion includes:
calculating the degree of congestion based on a third criterion which causes the degree of congestion to increase as an interval from a time when an occupancy of the shared facility is released to a time when the occupancy is resumed becomes narrow.

7. The method of claim 4, wherein the providing of information on the occupancy status includes:
providing a notification to a manager terminal of the residential space, when a degree of congestion in the residential space is higher than a reference degree of congestion calculated from the degrees of congestion in other residential spaces, for the shared facility and same type of shared facilities.

8. The method of claim 4, further comprising:
providing the residential spaces in a form of list by matching residential space information and occupancy status information for each of a plurality of residential spaces.

9. The method of claim 8, wherein the providing of the residential spaces in the form of list includes:
calculating a weight of the shared facility based on a filter setting for viewing the shared facility with a higher priority than a priority of other shared facilities, which is performed through another user application;
calculating a total score of degrees of congestion in all shared facilities of the residential space based on a value obtained by applying the weight to the degree of congestion in the shared facilities; and
adjusting an order on a list of the residential spaces based on the total score of degrees of congestion.

10. An apparatus for providing an occupancy status of shared facilities based on big data, the apparatus comprising:
a memory with at least one program recorded therein; and
a processor for executing the program,
wherein the program includes:
receiving sensing data indicating an occupancy state of shared facilities from a facility sensing terminal in a residential space, in the residential space where a plurality of users live while sharing certain facilities of a house;
generating information on an occupancy status for the shared facility based on the sensing data, residential space information collected for the residential space, and big data information collected for other residential spaces; and
providing information on an occupancy status for the shared facility through a user application.
